(19) United States
(12) Patent Application Publication
(10) Pub. No.: US 2026/0339839 A1
(43) Pub. Date: Oct. 29, 2026

(54) MEMORY SYSTEM INCLUDING HOST DEVICE AND MEMORY DEVICE, AND OPERATION METHOD THEREOF

(71) Applicant: XCENA Inc., Seongnam-si (KR)

(72) Inventors: Sangwon LEE, Seongnam-si (KR); Seonghyeon DO, Seongnam-si (KR)

(21) Appl. No.: 19/662,301

(22) Filed: Apr. 29, 2026

(30) Foreign Application Priority Data
Apr. 29, 2025 (KR) 10-2025-0056392

(51) Int. Cl. G06F 12/02; G06F 13/16

(52) U.S. Cl. CPC G06F 12/0292; G06F 13/1673

(57) ABSTRACT

A memory system includes a host memory configured to store instructions, and at least one processor communicating with the host memory and configured to access a memory device by executing the instructions, wherein the at least one processor is configured to generate a virtual address for accessing the memory device, configure a mapping table including mapping information between the virtual address and a physical address of a first internal memory of the memory device, and transmit the mapping table to the memory device, and the memory device is configured to convert the virtual address to the physical address of the first internal memory based on the mapping table.

### CROSS-REFERENCE TO RELATED APPLICATION

This application claims priority to Korean Patent Application No. 10-2025-0056392, filed in the Korean Intellectual Property Office on Apr. 29, 2025, the entire contents of which being hereby incorporated by reference.

### TECHNICAL FIELD

Embodiments relate to a memory system including a host device and a memory device, and an operation method thereof.

### BACKGROUND

As artificial intelligence, big data, and blockchain-based technologies develop, an accelerator, which is hardware designed to assist calculations of a central processing unit (CPU) or quickly process specific tasks, is widely used.

Because a Peripheral Component Interconnect Express (PCIe) based accelerator uses an independent memory, a copy overhead occurs when data moves between a host device and the PCIe based accelerator. The copy overhead causes performance degradation and causes a bottleneck in workloads such as deep learning and big data analysis.

To overcome the restrictions, an accelerator including a Compute Express Link (CXL) memory has emerged. The accelerator including the CXL memory may include both a device private memory (DPM) and a CXL host attached device memory (HDM), such that the copy overhead may be prevented when data moves between the host device and the accelerator including the CXL memory. However, additional processes are required as follows.

First, even if the HDM is disposed in the accelerator including the CXL memory, the HDM is in a control range of the host device, such that permission of the host device is required whenever the accelerator including the CXL memory uses the HDM.

Second, because the host device uses a memory address allocation method based on a virtual address, when the accelerator including the CXL memory accesses the HDM, the accelerator including the CXL memory must access the HDM based on a virtual address method to smoothly use a case where a contiguous address space in the virtual address is physically discontinuously configured or a pointer-based data structure (e.g., a linked list, a tree, etc.).

Meanwhile, as semiconductor technology develops, integration of electronic devices deepens and complexity increases. Therefore, it is desirable to operate the electronic devices accurately and at an improved speed. As described above, because the host device uses the memory address allocation method based on the virtual address, restrictions such as speed follow when the accelerator including the CXL memory uses the virtual address of the host device. Therefore, to prevent unnecessary overhead and speed degradation and to improve performance of the accelerator including the CXL memory in a process where the accelerator including the CXL memory accesses a memory, it is desirable to accurately and quickly access a physical address.

The above information disclosed in this background section is only for enhancement of understanding of the background, and therefore the above information may include information that does not form the prior art.

### SUMMARY

Embodiments provide a memory system including a host device and a memory device, and an operation method thereof for solving the above problems.

Embodiments may be implemented in various ways including a method, an apparatus (system), or a computer program stored in a readable storage medium.

In some embodiments, a memory system may include a host memory configured to store instructions, and at least one processor communicating with the host memory and configured to access a memory device by executing the instructions, wherein the at least one processor is configured to generate a virtual address for accessing the memory device, configure a mapping table may include mapping information between the virtual address and a physical address of a first internal memory of the memory device, and transmit the mapping table to the memory device, and the memory device is configured to convert the virtual address to the physical address of the first internal memory based on the mapping table.

In some embodiments, the memory device may include a second internal memory configured to store the mapping table, and a processing unit may include a memory management unit and a page buffer configured to access the first internal memory based on the physical address.

In some embodiments, the at least one processor is further configured to, prior to offloading an operation to the memory device, update the mapping table based on a first virtual address corresponding to the offloading.

In some embodiments, the memory management unit converts the first virtual address to a first physical address based on the updated mapping table, and the processing unit is configured to perform the offloaded operation based on data read based on the first physical address.

In some embodiments, the memory management unit is configured to lookup a second virtual address received from the at least one processor in the page buffer.

In some embodiments, the memory management unit is configured to acquire a second physical address corresponding to the second virtual address by looking up the second virtual address in the mapping table, in response to failing to lookup the second virtual address in the page buffer.

In some embodiments, the at least one processor is further configured to add mapping information corresponding to a third virtual address to the mapping table, in response to mapping information of the third virtual address to be transmitted to the memory device not being comprised in the mapping table.

In some embodiments, the at least one processor and the memory device are configured to communicate based on a Compute Express Link (CXL) protocol.

In some embodiments, a method of operating a host device and a memory device, the method may include generating, by the host device, a virtual address for accessing the memory device, configuring, by the host device, a mapping table may include mapping information between the virtual address and a physical address of a first internal memory of the memory device, transmitting, by the host device, the mapping table to the memory device, and converting, by the memory device, the virtual address to the physical address of the first internal memory based on the mapping table.

In some embodiments, the configuring the mapping table may include updating the mapping table based on a first virtual address corresponding to an offloading, prior to offloading an operation to the memory device.

In some embodiments, the converting the virtual address to the physical address of the first internal memory may include converting the first virtual address to a first physical address based on the updated mapping table, and the method further may include performing the offloaded operation based on data read based on the first physical address.

In some embodiments, the configuring the mapping table may include adding mapping information corresponding to a second virtual address to the mapping table, in response to mapping information of the second virtual address to be transmitted to the memory device not being comprised in the mapping table.

In some embodiments, the host device and the memory device are configured to communicate based on a Compute Express Link (CXL) protocol.

In some embodiments, a memory system may include a host device and a memory device, wherein the host device may include a host memory configured to store instructions, and at least one processor communicating with the host memory and configured to access the memory device by executing the instructions, the memory device may include an internal memory may include a first internal memory and a second internal memory, and a processing unit configured to convert an address to perform an operation, the at least one processor is configured to generate a virtual address for offloading an operation to the memory device, configure a mapping table may include mapping information between the virtual address and a physical address of the first internal memory of the memory device, and transmit the mapping table to the memory device, and the processing unit is configured to convert the virtual address to the physical address based on the mapping table, and perform the operation offloaded by the host device based on data read from the first internal memory based on the physical address.

In some embodiments, the host device is further configured to add mapping information corresponding to a first virtual address to the mapping table, in response to mapping information of the first virtual address generated for offloading a first operation not being comprised in the mapping table.

According to aspects of some embodiments, by providing metadata mapping a virtual address of a host and a physical address of an internal memory (or, a device memory) of the memory device to the memory device, the memory device (or, a memory accelerator) may quickly convert the virtual address to the physical address. That is, without the memory device having to refer to a page table of the host to access an internal memory of the memory device itself, the memory device may directly convert the virtual address to the physical address through internal metadata. Through the direct conversion, an overhead occurring by referring to the page table of the host may be effectively reduced, such that an address conversion operation may be efficiently performed, and performance of the memory device may be improved.

According to aspects of some embodiments, by storing the metadata mapping the virtual address of the host and the physical address of the device memory also within the host device, it may be guaranteed that an unmapped virtual address is not transmitted to the memory device. Because of the guarantee, an error of failing to convert the virtual address may be prevented, and an inefficient address conversion operation occurring because an unguaranteed virtual address is transferred to the memory device may be prevented.

According to aspects of some embodiments, by updating the mapping table according to generation of the virtual address of the host, and providing the updated mapping table to the memory device, mapping information between the host and the memory device may be synchronized. Through the synchronization, a more accurate and efficient address conversion process may be provided.

According to aspects of some embodiments, before the host offloads the operation to the memory device, by pre-emptively performing the update of the mapping table based on the virtual address corresponding to the operation, an address conversion (that is, a hit) may be guaranteed.

According to aspects of some embodiments, by guaranteeing that the memory device may succeed in the address conversion in the mapping table even in a worst case, quick access to the device memory and improved performance of the accelerator may always be guaranteed.

According to aspects of some embodiments, before the host device offloads the operation to the memory device, even if the virtual address for accessing the memory device is not stored in the metadata, accurate mapping information may be maintained by adding a new page table entry corresponding to the virtual address to the metadata.

Effects of the present disclosure are not limited to the above-mentioned effects, and other effects not mentioned will be clearly understood by a person having ordinary knowledge in the technical field to which the present disclosure belongs (referred to as a "person skilled in the art") from the description of the claims.

### BRIEF DESCRIPTION OF THE DRAWINGS

The above and other embodiments and features of the present disclosure will become more apparent by describing in detail example embodiments thereof with reference to the attached drawings, in which:

FIG. 1 is a block diagram illustrating an example of a memory system according to an embodiment.

FIG. 2 is a block diagram illustrating an example of a host device according to an embodiment.

FIG. 3 illustrates an example of a memory device according to an embodiment.

FIG. 4 illustrates an example of a memory access according to an embodiment.

FIG. 5 illustrates an example of a mapping table according to an embodiment.

FIG. 6 illustrates an example of an address conversion according to an embodiment.

FIG. 7 is a flowchart illustrating an example of an arithmetic operation according to an embodiment.

FIG. 8 illustrates an example of an address conversion according to an embodiment.

FIG. 9 illustrates an example of a mapping table according to an embodiment.

FIG. 10 is a flowchart illustrating an example of an address conversion method according to an embodiment.

FIG. 11 is a flowchart illustrating an example of an arithmetic process according to an embodiment.

Embodiments will be described with reference to the accompanying drawings described below, where like reference numbers indicate like elements, but are not limited thereto.

### DETAILED DESCRIPTION

Hereinafter, specific details for implementation of the present disclosure will be described in detail with reference to the accompanying drawings. However, in the following description, in a case where there is a concern of unnecessarily obscuring a gist of the present disclosure, a detailed description of widely known functions or configurations will be omitted.

In the accompanying drawings, identical or corresponding components are given identical reference numerals. In addition, in the description of the following embodiments, overlapping descriptions of identical or corresponding components may be omitted. However, even if a description of a component is omitted, it is not intended that the component is not included in an embodiment.

Advantages and features of the disclosed embodiments, and a method of achieving them, will become clear with reference to the embodiments described below together with the accompanying drawings. However, the present disclosure is not limited to the embodiments disclosed below and may be implemented in various different forms, and the present embodiments are only provided to complete the present disclosure and to completely inform a person skilled in the art of the scope of the invention.

Terms used in this specification will be briefly described, and the disclosed embodiments will be described in detail. General terms currently widely used as much as possible while considering functions in the present disclosure are selected for the terms used in this specification, but this may vary according to an intention or precedent of a technician working in a related field, emergence of a new technology, and the like. For example, in a specific case, there is a term arbitrarily selected by an applicant, and in this case, a meaning of the term will be described in detail in a description part of the corresponding invention. Therefore, the term used in the present disclosure should be defined based on the meaning of the term and the overall contents of the present disclosure, rather than a simple name of the term.

Singular expressions in this specification include plural expressions unless the context clearly specifies that the singular expression is singular. In addition, plural expressions include singular expressions unless the context clearly specifies that the plural expression is plural. Throughout the specification, when a part includes a component, this means that the part may further include other components, rather than excluding the other components, unless otherwise stated.

The term "module" or "unit" used in the specification means software or a hardware component such as a Field Programmable Gate Array (FPGA) or an Application Specific Integrated Circuit (ASIC), and the "module" or "unit" may perform certain roles. However, the "module" or "unit" is not meant to be limited to software or hardware. The "module" or "unit" may be configured to reside in an addressable storage medium, or may be configured to reproduce one or more processors. Therefore, as an example, the "module" or "unit" may include components such as software components, object-oriented software components, class components, and task components, processes, functions, attributes, procedures, subroutines, segments of program code, drivers, firmware, microcode, circuits, data, a database, data structures, tables, arrays, and variables. A function provided within the components and the "modules" or "units" may be combined into a smaller number of components and the "modules" or "units," or may be further separated into additional components and the "modules" or "units."

According to an embodiment, the "module" or "unit" may be implemented with a processor and a memory. "Processor" should be broadly interpreted to include a general-purpose processor, a central processing unit (CPU), a microprocessor, a digital signal processor (DSP), a controller, a microcontroller, a state machine, and the like. In some environments, the "processor" may refer to an application specific integrated circuit (ASIC), a programmable logic device (PLD), a field programmable gate array (FPGA), and the like. The "processor" may refer to a combination of processing devices such as, for example, a combination of a DSP and a microprocessor, a combination of a plurality of microprocessors, a combination of one or more microprocessors combined with a DSP core, or any other combination of such configurations. In addition, "memory" should be broadly interpreted to include any electronic component capable of storing electronic information. "Memory" may refer to various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, and the like. A memory is said to be in electronic communication with the processor if the processor may read information from and/or write information to the memory. The memory integrated into the processor is in electronic communication with the processor.

In addition, terms such as first, second, etc. used in the following embodiments are only used to distinguish a component from other components, and an essence, order, or sequence of the corresponding component is not limited by the terms.

In addition, in the following embodiments, when it is described that a component is "connected", "coupled", or "attached" to another component, the component may be directly connected or attached to the other component, but it should be understood that various other components may be "connected", "coupled", or "attached" between each component.

In addition, "include" and/or "including" used in the following embodiments do not exclude a presence or addition of one or more other components, steps, operations, and/or elements to mentioned components, steps, operations, and/or elements.

In the present disclosure, "system" may include at least one device of a server device and a cloud device, but is not limited thereto. For example, the system may be composed of one or more server devices. As another example, the system may be composed of one or more cloud devices. As another example, the system may be configured and operated with the server device and the cloud device together.

In the present disclosure, "each of a plurality of As" or "each of the plurality of As" may refer to each of all components included in the plurality of As, or may refer to each of some components included in the plurality of As.

Hereinafter, various embodiments will be described in detail according to the accompanying drawings. A position and/or a structure of various configurations and/or blocks shown and described in the drawings are exemplary, and are not limited thereto. For example, some configurations may be added or omitted, or configured in positions and structures different from those shown. In addition, the flowcharts shown in the drawings and the description thereof are only an example, and may be implemented differently in some embodiments. For example, one or more steps may be omitted, an order of each step may be changed, one or more steps may be performed overlapping, or one or more steps may be repeatedly performed several times.

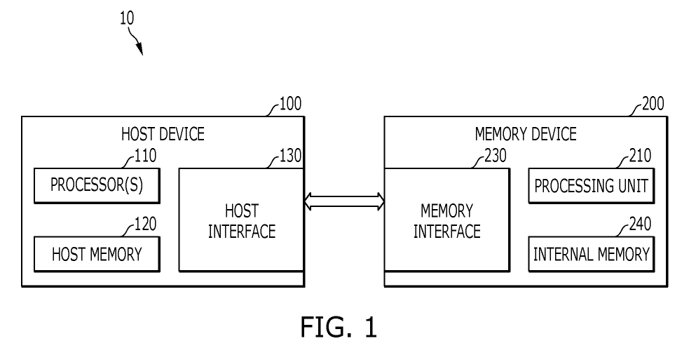

FIG. 1 is a block diagram illustrating an example of a memory system according to an embodiment.

Referring to FIG. 1, a memory system 10 may include a host device 100 and a memory device 200. The memory system 10 may include, for example, a combination of hardware and software capable of processing data and performing an arithmetic operation, and may include a storage server or another kind of server that may be used in a data center. The host device 100 and the memory device 200 may communicate with each other based on various communication protocols.

The host device 100 may include a processor 110, a host memory 120, and a host interface 130. The processor 110 may include a set of one or more processors. The processor 110 may control at least one component of a device or terminal (e.g., the memory device 200) connected to the processor 110 by driving software (e.g., an instruction, a program, etc.). In addition, the processor 110 may perform operations such as various arithmetic operations, processing, data generation, or data modification. In addition, the processor 110 may load data and the like from various memory devices or the memory device 200 or store the data and the like in the various memory devices or the memory device 200.

The host memory 120 is a memory actively used by the processor 110, and may include at least one of a random access memory (RAM), a cache memory, a non-volatile memory, and a unified memory, but is not limited thereto.

The memory device 200 may include a processing unit 210, a memory interface 230, and an internal memory 240. The memory device 200 may be a configuration that performs a specific task according to a command of the processor 110. That is, the memory device 200 may be a device for performing an offloading (a distributed processing) including at least one of artificial intelligence inference, image processing, or data analysis. For example, the memory device 200 may be a Compute Express Link (CXL) memory device, but the present disclosure is not limited thereto. The memory device 200 may be implemented as various external memory devices.

The processing unit 210 may perform the operation offloaded from the host device 100. In an embodiment, the processing unit 210 may include a graphics processing unit (GPU), a tensor processing unit (TPU), a neural processing unit (NPU), a field-programmable gate array (FPGA), an application-specific integrated circuit (ASIC), and the like, but the present disclosure is not limited thereto.

The processor 110 of the host device 100 may communicate with the memory device 200 through the host interface 130. The host interface 130 may be an interface based on serial communication, but the present disclosure is not limited thereto. Similarly, the processing unit 210 of the memory device 200 may communicate with the processor 110 through the memory interface 230. The memory interface 230 may be an interface based on serial communication, and may include one or more communication ports. The memory interface 230 may be an interface using a Peripheral Component Interconnect Express (PCIe) or Compute Express Link (CXL) protocol, but the present disclosure is not limited thereto.

The processor 110 may transmit a command for the offloading to the memory device 200. The processor 110 may copy and use data based on Direct Memory Access (DMA) to access the internal memory 240 of the memory device 200. In addition, the processor 110 may access a host memory area of the memory device 200 to load or store data based on a virtual addressing method.

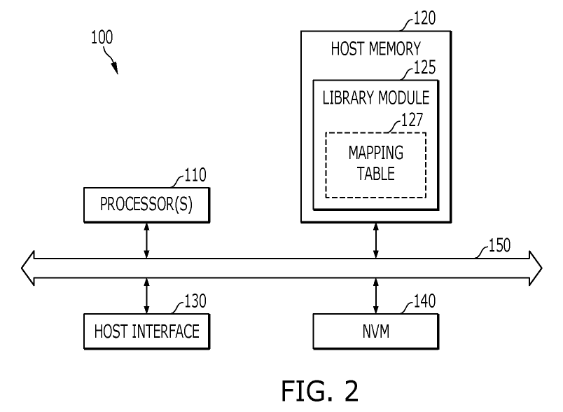

FIG. 2 is a block diagram illustrating an example of a host device according to an embodiment.

Referring to FIGS. 1 and FIG. 2 , the host device 100 may include the processor 110, the host memory 120, the host interface 130, and a non-volatile memory 140, and the processor 110, the host memory 120, the host interface 130, and the non-volatile memory 140 may communicate with each other through a first bus 150. For example, the host device 100 may be implemented as an application processor (AP) or a system-on-chip (SoC).

The processor 110 may include a central processing unit (CPU) or a microprocessor, and may control an overall operation of the host device 100. The processor 110 may include a plurality of processing cores independently performing an arithmetic operation. The processor 110 may be, for example, a CPU capable of performing a large-scale parallel arithmetic operation. However, the present disclosure is not limited thereto, and the processor 110 may be implemented as a GPU, an NPU, and the like.

The processor 110 may execute various application programs or tools to be driven on an operating system (OS) base. In an embodiment, the processor 110 may be configured to execute instructions performing at least one of various operations for accessing an external memory device (e.g., the memory device 200). For example, a library module 125 loaded into the host memory 120 may be loaded from the non-volatile memory 140 to the host memory 120 and driven by the processor 110.

The library module 125 may be a software module for effectively controlling and managing an external memory resource (e.g., the memory device 200) through the host interface 130 and the like in the memory system 10. In an embodiment, the memory device 200 may be a CXL memory device, and the library module 125 may be a CXL memory library for controlling the CXL memory device through a CXL interface. Here, the library module 125 may process read/write commands for the CXL memory device (that is, the memory device 200) in accordance with the CXL protocol, and perform basic memory management functions such as memory resource allocation and release. The library module 125 is not limited to the present embodiment, and may provide various functions for communication between the host device 100 and the memory device 200. For example, the library module 125 may include a function of managing cache coherency between the host device 100 and the memory device 200 to guarantee data coherency throughout the memory system 10.

In an embodiment, the processor 110 may drive the library module 125 to provide an address mapping function between the host device 100 and the memory device 200 (e.g., the CXL memory device). The library module 125 may be in charge of address mapping and conversion to support upper software to consistently access the memory resource. In an embodiment, the library module 125 may store a mapping table (or a page table) 127 including mapping information between a virtual address requested by the processor 110 and a physical address of the internal memory 240 of the memory device 200. That is, the processor 110 may drive the library module 125 to configure (e.g., generate, change, and/or delete) the mapping table 127 and store the mapping table 127 in the library module 125. Although not shown, the processor 110 may further drive various other modules for controlling the host device 100 and/or the memory system 10.

The host memory 120 may operate under control of the processor 110 as described above, and in an embodiment, the host memory 120 may be a volatile memory and implemented as a DRAM. The host memory 120 may refer to a memory loaded with the mapping table 127, which is metadata. An operating system (OS) or application programs may be loaded into the host memory 120. When the memory system 10 boots, an OS image stored in the non-volatile memory 140 may be loaded into the host memory 120 based on a boot sequence. Overall input/output operations of the memory system 10 may be supported by the operating system (OS). Similarly, application programs (e.g., the library module 125) selected by a user or for providing a basic service may be loaded into the host memory 120.

The host interface 130 may provide a communication function with the memory device 200 as described above. Meanwhile, the host interface 130 may function as an I/O interface. That is, the host interface 130 may control user inputs and outputs from various devices. For example, the host interface 130 may include an input device such as a keyboard, a mouse, or a touch pad to receive various information, and may include an output device such as a monitor to display progress and processing results of various operations.

The non-volatile memory 140 may be provided as a storage medium of the host device 100. The non-volatile memory 140 may store application programs, an operation system (OS) image, and various data. In an embodiment, the non-volatile memory 140 may store various data related to the library module 125. The non-volatile memory 140 may be provided as a memory card (MMC, eMMC, SD, MicroSD, etc.) or a hard disk drive (HDD). The non-volatile memory 140 may include a NAND-type flash memory having a large storage capacity. Alternatively, the non-volatile memory 140 may include a next-generation non-volatile memory such as a PRAM, an MRAM, a ReRAM, and an FRAM, or a flash memory.

The first bus 150 may be provided as an interconnector for providing a network inside the host device 100. The processor 110, the host memory 120, the host interface 130, and the non-volatile memory 140 may be electrically connected and exchange data with each other through the first bus 150. However, a configuration of the first bus 150 is not limited to the above description, and may further include arbitration means for efficient management.

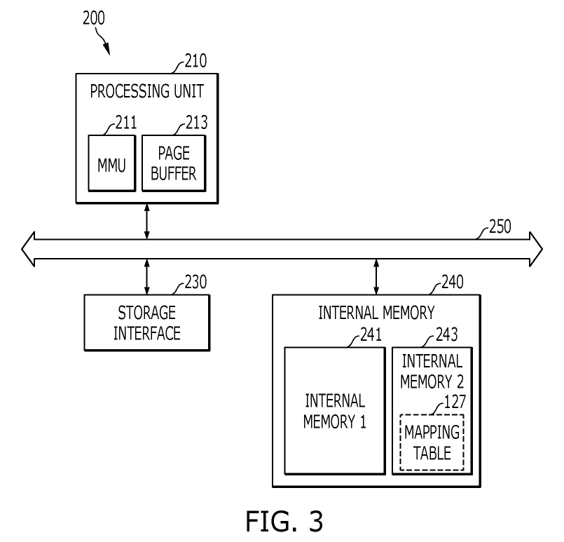

FIG. 3 illustrates an example of a memory device according to an embodiment.

Referring to FIGS. 1 -3, the memory device 200 may include the processing unit 210, the memory interface 230, and the internal memory (that is, a device memory) 240, and the processing unit 210, the memory interface 230, and the internal memory 240 may communicate with each other through a second bus 250. The internal memory 240 may include a first internal memory 241 and a second internal memory 243. In an embodiment, the first internal memory 241 may be a memory area managed by the host device 100, and the second internal memory 243 may be a dedicated memory area of the memory device 200 that is not exposed to the host device 100 and is accessed only by the memory device 200. As described above, the processing unit 210 may be a unit for performing an offloading (a distributed processing). A description overlapping with that described in FIG. 1 may be omitted.

In an embodiment, the host device 100 may drive the library module 125 to transmit the generated mapping table 127 to the memory device 200, and the memory device 200 may store the mapping table 127 received from the host device 100 in the second internal memory 243. The mapping table 127 may be metadata including mapping information between a virtual address requested by the host device 100 and a physical address of the first internal memory 241 of the memory device 200.

The processing unit 210 may include a memory management unit (MMU) 211 of its own and a page buffer (e.g., a translation lookaside buffer) 213. The memory management unit 211 may be a unit converting the virtual address received from the host device 100 into the physical address of the first internal memory 241. The page buffer 213 may store mapping information frequently used (or recently used) by the processing unit 210. That is, a page table entry (PTE) may be stored in the page buffer 213. In an embodiment, when receiving the virtual address from the host device 100, the memory management unit 211 may first lookup the page buffer 213. In a case where the lookup fails, the memory management unit 211 may access the mapping table 127 stored in the second internal memory 243.

The internal memory 240 may be provided as a storage medium of the memory device 200. In an embodiment, the internal memory 240 may be a CXL memory. The internal memory 240 may include a device-only memory area (e.g., the second internal memory 243) of the memory device 200 and a host memory area (e.g., the first internal memory 241) associated with the host device 100, and the host memory area may be included in a control range of the processor 110. For example, the second internal memory 243, which is the device-only memory area, may be a device-only memory of the memory device 200 supporting a CXL.io protocol. The first internal memory 241, which is the host memory area, may support a CXL.mem protocol that provides an expanded memory by utilizing a shared memory. The first internal memory 241, which is the host memory area, is a memory area disposed in the memory device 200 but managed by a host, and may include data satisfying cache coherence with the non-volatile memory 140 in the host device 100. The processor 110 may manage the non-volatile memory 140 and the host memory area included in the host device 100. For example, the processor 110 may manage the host memory area based on a virtual address method, which is an addressing method of the host device 100.

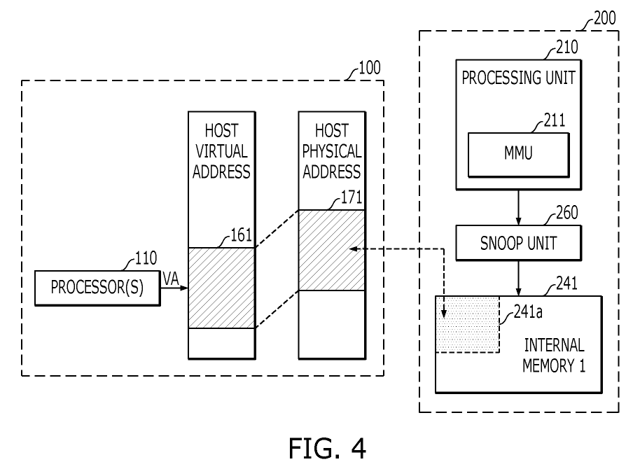

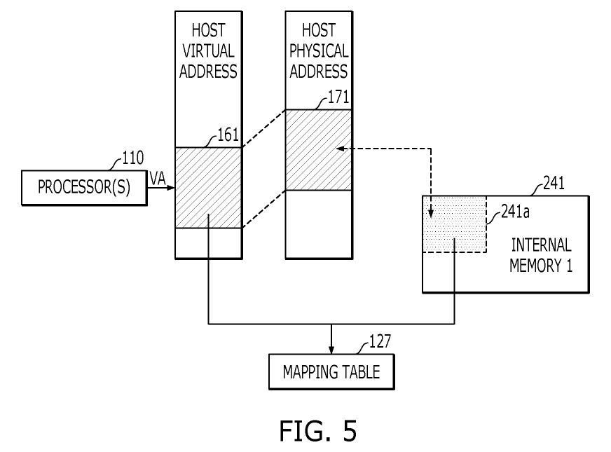

FIG. 4 illustrates an example of a memory access according to an embodiment. FIG. 5 illustrates an example of a mapping table according to an embodiment.

Referring to FIG. 4, the processing unit 210 of the memory device 200 may determine whether to access the first internal memory 241, which is the host memory area, based on a value of a specific address bit set by an offloading runtime.

As described above, the processor 110 may drive the library module 125 to provide an address mapping function between the host device 100 and the memory device 200. More specifically, when receiving a command accessing the first internal memory 241, which is the host memory area, by the processing unit 210, the memory management unit 211 may convert a first host virtual address 161 set by the processor 110 into an address space of a first host memory area 241a of the first internal memory 241. The processor 110 may convert a virtual address VA generated by the host into a first host physical address 171 by a host OS and a memory management unit of the host, and then transfer the first host physical address 171 to the memory device 200. In an embodiment, the memory device 200 may convert the first host physical address 171 into an address of the first host memory area 241a according to an address mapping method set by a CXL standard. That is, the virtual address VA generated by the host may be converted into a physical address of the first host memory area 241a of the first internal memory 241. A snoop unit 260 may satisfy coherence of the first host memory area 241a and the first host physical address 171.

Referring to FIG. 5, as described above, the processor 110 may drive the library module 125 to allocate memory according to the virtual address VA generated by the processor 110, and here, in an allocation process, the processor 110 may generate (configure) the mapping table 127 including mapping information between the virtual address VA and the physical address of the first host memory area 241a of the first internal memory 241. That is, in the allocation process of the first internal memory 241 corresponding to the virtual address VA, the processor 110 may convert the first host virtual address 161 into the physical address space of the first host memory area 241a of the first internal memory 241, and based on this, the processor 110 may generate the mapping table 127 including mapping information between the virtual address VA of the host device 100 and the physical address of the memory device 200.

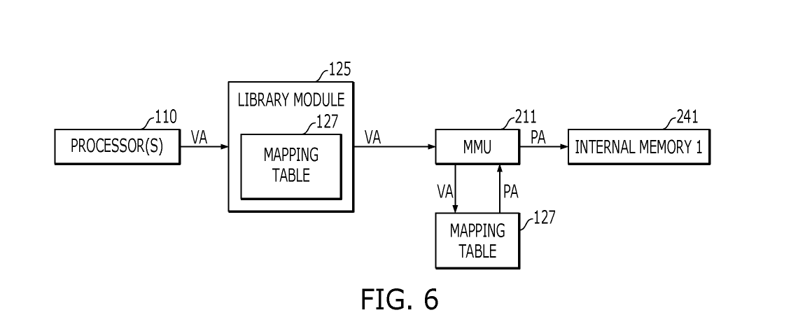

FIG. 6 illustrates an example of an address conversion according to an embodiment.

Referring to FIG. 6, the processor 110 may store the mapping table 127 including mapping information between the virtual address VA of the host device 100 and the physical address of the memory device 200, generated by driving the library module 125, in the library module 125.

In an embodiment, the processor 110 may transmit the mapping table 127 to the memory device 200, and the memory device 200 may store the received mapping table 127 in the internal memory 240 (e.g., the second internal memory 243). Thereafter, the processor 110 may generate the virtual address VA to use the memory device 200 (e.g., to offload a specific operation). In an embodiment, the library module 125 may first check the virtual address VA to be transmitted to the memory device 200. That is, the library module 125 may check whether the virtual address VA generated by the processor 110 exists in a page table entry of the mapping table 127 based on the mapping table 127. When the page table entry corresponding to the virtual address VA does not exist in the mapping table 127, because the virtual address VA does not access the internal memory 240 of the memory device 200, the library module 125 may block transmission of the virtual address VA to the memory device 200. In other words, the library module 125 may guarantee that the virtual address VA not mapped to the internal memory 240 of the memory device 200 is not transferred to the memory device 200.

When the page table entry corresponding to the virtual address VA exists in the mapping table 127, the library module 125 may transmit the virtual address VA to the memory management unit 211 of the memory device 200. The memory management unit 211 may directly look up the virtual address VA in the mapping table 127, and accordingly may directly acquire a physical address PA corresponding to the virtual address VA. The memory management unit 211 may directly access the first internal memory 241 based on the acquired physical address PA.

In a memory system according to an embodiment, by providing metadata mapping a virtual address of a host and a physical address of a device memory to the memory device, the memory device (or, an accelerator) may quickly convert the virtual address to the physical address. That is, without the memory device having to refer to a page table of the host to access an internal memory of the memory device itself, the memory device may directly convert the virtual address to the physical address through internal metadata. Through the direct conversion, an overhead occurring by referring to the page table of the host may be effectively reduced, such that an address conversion operation may be efficiently performed, and performance of the memory device may be improved.

In some embodiments, in the memory system according to an embodiment, by storing the metadata mapping the virtual address of the host and the physical address of the device memory also within the host device, it may be guaranteed that an unmapped virtual address is not transmitted to the memory device. Because of the guarantee, an error of failing to convert the virtual address may be prevented, and an inefficient address conversion operation occurring because an unguaranteed virtual address is transferred to the memory device may be prevented.

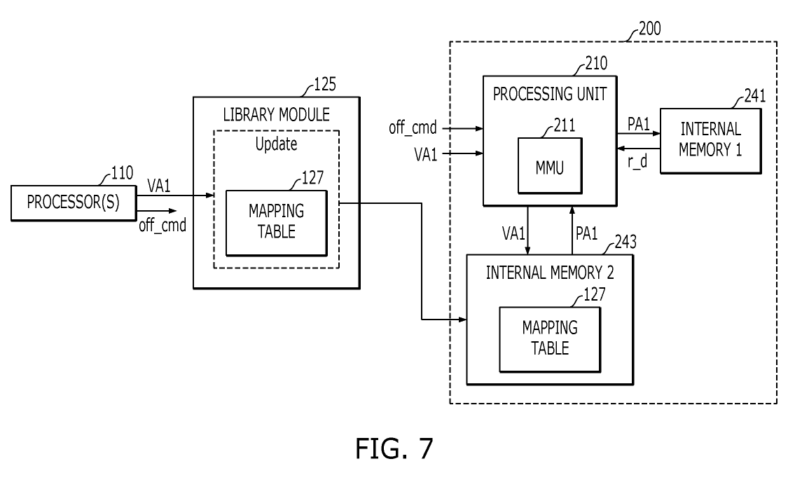

FIG. 7 is a flowchart illustrating an example of an arithmetic operation according to an embodiment.

Referring to FIG. 7, the processor 110 may provide an accurate and efficient address conversion process by updating the mapping table 127 before offloading an operation.

For example, the processor 110 may transmit an offloading command off_cmd corresponding to a first operation to the memory device 200. Before transmitting the offloading command off_cmd, the processor 110 may transmit a first virtual address VA1 corresponding to the offloading command off_cmd (that is, necessary for performing the offloading command off_cmd) to the library module 125. The library module 125 may map a physical address space of the first internal memory 241 corresponding to the first virtual address VA1, and reflect a mapping result to the mapping table 127 (that is, may update the mapping table 127). The library module 125 may transmit the updated mapping table 127 to the memory device 200, and the memory device 200 may store the updated mapping table 127 in the second internal memory 243.

Thereafter, the processor 110 may transmit the offloading command off_cmd corresponding to the first operation to the memory device 200, and the processing unit 210 may receive the offloading command off_cmd and the first virtual address VA1 for accessing data necessary for an operation. The memory management unit 211 may refer to the mapping table 127 to query a page table entry corresponding to the first virtual address VA1, and may convert the first virtual address VA1 into a first physical address PA1 based on the page table entry. The memory management unit 211 may directly access the first internal memory 241 to read corresponding data r_d based on the first physical address PA1. The processing unit 210 may perform the first operation offloaded by the processor 110 based on the offloading command off_cmd and the read data r_d.

In the memory system according to an embodiment, by updating the mapping table according to generation of the virtual address of the host, and providing the updated mapping table to the memory device, mapping information between the host and the memory device may be synchronized. Through the synchronization, a more accurate and efficient address conversion process may be provided.

In some embodiments, in the memory system according to an embodiment, before the host offloads the operation to the memory device, by pre-emptively performing the update of the mapping table based on the virtual address corresponding to the operation, an address conversion (that is, a hit) may be guaranteed.

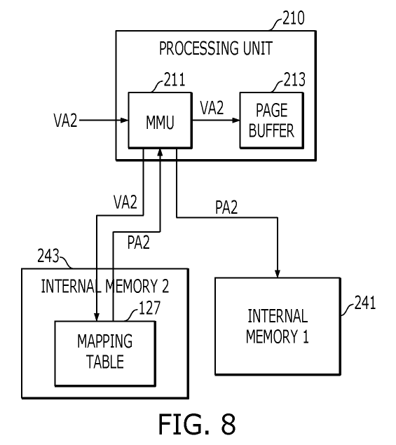

FIG. 8 illustrates an example of an address conversion according to an embodiment.

Referring to FIG. 8, address conversion of the memory management unit 211 may always be guaranteed. The processing unit 210 may receive a second virtual address VA2 from the host device 100. As described above, the library module 125 may first check a virtual address to be transmitted and then transmit the virtual address to the memory device 200. The memory management unit 211 may receive the second virtual address VA2 and first query the page buffer 213. That is, when the second virtual address VA2 is a virtual address frequently (or recently) transmitted to the processing unit 210, the page buffer 213 may cache a corresponding page table entry. When successfully querying the page table entry in the page buffer 213 (that is, a TLB hit), the memory management unit 211 may convert the second virtual address VA2 into a second physical address PA2 based on the page table entry, and may directly access the first internal memory 241.

For example, even if the memory management unit 211 fails to query the page table entry in the page buffer 213 (that is, a TLB miss), the memory management unit 211 may always query the page table entry corresponding to the second virtual address VA2 by querying the mapping table 127 stored in the second internal memory 243. That is, because a virtual address transmitted by the library module 125 is always mapped to the mapping table 127 (that is, because an update is always performed and synchronized based on a virtual address), the memory management unit 211 may always acquire the second physical address PA2 corresponding to the second virtual address VA2. That is, a page fault does not occur during an address conversion process. Similarly, the memory management unit 211 may directly access the first internal memory 241 with the acquired second physical address PA2.

In the memory system according to an embodiment, by guaranteeing that the memory device may succeed in the address conversion in the mapping table even in a worst case, quick access to the device memory and improved performance of the accelerator may always be guaranteed.

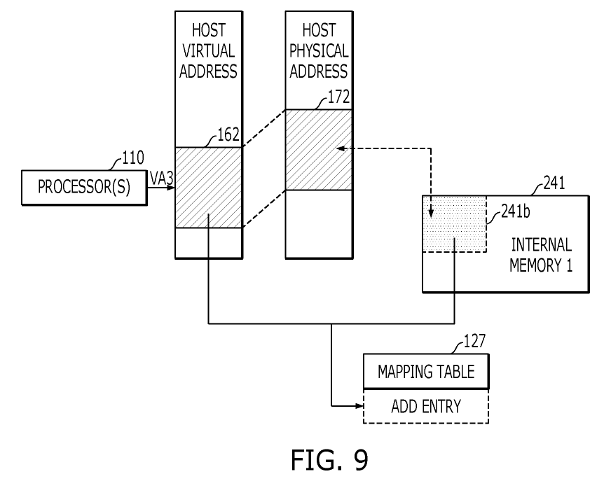

FIG. 9 illustrates an example of a mapping table according to an embodiment.

Referring to FIG. 9, even when generating a virtual address not mapped to the mapping table 127, the processor 110 may add a page table entry corresponding to a virtual address through the mapping operation described above.

The processor 110 may generate a third virtual address VA3 accessing the first internal memory 241, and a page table entry corresponding to the third virtual address VA3 may not exist in the mapping table 127. That is, the first host virtual address 161 corresponding to an existing generated virtual address and a second host virtual address 162 corresponding to the third virtual address VA3 may be different from each other, and accordingly, the first host physical address 171 and a second host physical address 172 may also be different from each other. As a result, the third virtual address VA3 may not correspond to the first host memory area 241a corresponding to an existing generated virtual address, and accordingly, the processor 110 may drive the library module 125 to add a new page table entry to the mapping table 127. In an embodiment, the library module 125 may newly map a second host memory area 241b converted according to an address mapping method set by a CXL standard, and may store newly mapped information (that is, a newly added page table entry) by adding the newly mapped information to the existing mapping table 127.

In the memory system according to an embodiment, even if a virtual address accessing the memory device is not stored in metadata, accurate mapping information may be maintained by adding a new page table entry corresponding to a virtual address to the metadata.

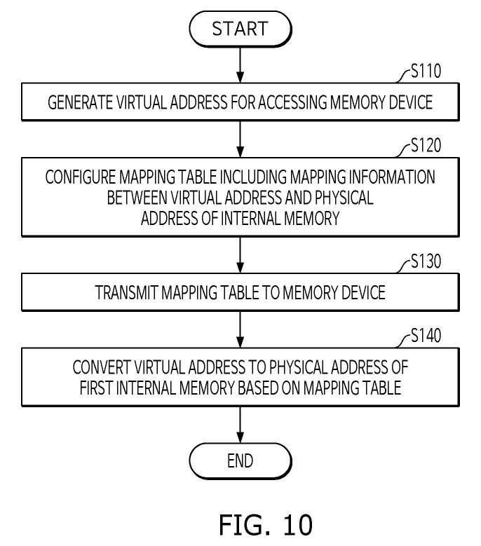

FIG. 10 is a flowchart illustrating an example of an address conversion method according to an embodiment.

An address conversion method according to an embodiment may include step S110 to step S140. The address conversion method according to an embodiment may be performed by the host device 100, the memory device 200, the memory system 10, and/or various electronic devices described with reference to FIGS. 1 - 9, and overlapping descriptions may be omitted.

In step S110, the host device may generate a virtual address for accessing the memory device. For example, the host device may generate a virtual address for offloading an operation to the memory device.

In step S120, the host device may configure a mapping table (or, a page table) including mapping information between a virtual address for accessing the memory device and a physical address of an internal memory (a device memory) that is a memory of the memory device itself. In a memory allocation process according to a virtual address, the host device may generate the mapping table by driving a software module responsible for address mapping loaded into a main memory in the host device.

In step S130, the host device may store a generated mapping table in a main memory of the host device itself, and transmit the mapping table to the memory device. The memory device may receive the mapping table and store the mapping table in an internal memory of the memory device itself.

In step S140, the memory device may directly convert a virtual address received from the host device into a physical address of an internal memory (a device memory) (e.g., the first internal memory 241 of FIG. 3) based on the mapping table.

That is, to convert a virtual address received from the host device, without the memory device having to refer to a page table of the host device, the memory device may directly convert a virtual address into a physical address through a mapping table, which is stored metadata. Therefore, to access a memory of the memory device itself, without having to access the host device, the memory device may directly access a memory through internal data.

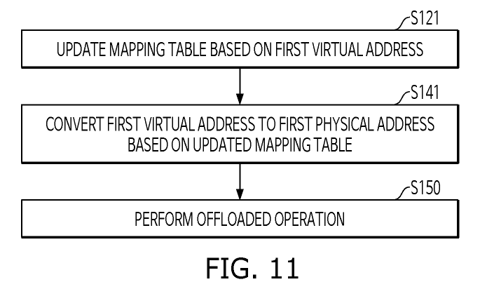

FIG. 11 is a flowchart illustrating an example of an arithmetic process according to an embodiment.

Referring to FIG. 11, an address conversion method according to an embodiment may update a mapping table in real time, and by synchronizing an updated mapping table with a memory device, the memory device may perform a fast and efficient offloading operation.

In step S121, before transmitting an offloading command to the memory device, the host device may generate a first virtual address necessary for the memory device to perform the offloading command. As described above, the host device may map a physical address space of an internal memory (e.g., the first internal memory 241 of FIG. 3) of the memory device corresponding to the first virtual address, and update a mapping result in the mapping table. The host device may transmit an updated mapping table to the memory device, and the memory device may store the updated mapping table in an internal memory (e.g., the second internal memory 243 of FIG. 3). After updating, the host device may transmit an offloading command to the memory device, and the memory device may receive the offloading command and the first virtual address.

In step S150, the memory device may perform an offloaded operation. More specifically, the memory device may refer to the updated mapping table to query a page table entry corresponding to the first virtual address, and may convert the first virtual address into a physical address based on the page table entry. The memory device may perform an operation offloaded by the host device based on data read based on the physical address and the offloading command.

Flowcharts and detailed descriptions shown in FIGS. 10 and 11 are merely examples, and may be implemented differently in other embodiments. For example, an order of some steps may be changed, some steps may be omitted, or another configuration may be added, and some steps described as being performed sequentially may be performed simultaneously.

In a hardware implementation, a processor of the host device and/or processing units of the memory device used to perform techniques may be implemented within one or more ASICs, DSPs, GPUs, digital signal processing devices (DSPDs), programmable logic devices (PLDs), field programmable gate arrays (FPGAs), processors, controllers, microcontrollers, microprocessors, electronic devices, other electronic units designed to perform functions described in the present disclosure, a computer, or a combination thereof.

Although the present disclosure has been described with reference to some embodiments in the present specification, various modifications and changes may be made within a range that does not depart from a scope of the present disclosure that may be understood by a person having ordinary knowledge in a technical field to which an invention of the present disclosure belongs. In addition, it should be considered that such modifications and changes fall within a scope of claims attached to the present specification.

What is claimed is:

1. A memory system comprising:
a host memory configured to store instructions; and
at least one processor communicating with the host memory and configured to access a memory device by executing the instructions,
wherein the at least one processor is configured to:
generate a virtual address for accessing the memory device;
configure a mapping table comprising mapping information between the virtual address and a physical address of a first internal memory of the memory device; and
transmit the mapping table to the memory device, and
wherein the memory device is configured to convert the virtual address to the physical address of the first internal memory based on the mapping table.

2. The memory system as claimed in claim 1, wherein the memory device comprises:
a second internal memory configured to store the mapping table; and
a processing unit comprising a page buffer configured to access the first internal memory based on the physical address.

3. The memory system as claimed in claim 2, wherein the at least one processor is further configured to, prior to offloading an operation to the memory device, update the mapping table based on a first virtual address corresponding to the offloading.

4. The memory system as claimed in claim 3, wherein the processing unit is configured to convert the first virtual address to a first physical address based on the updated mapping table, and
wherein the processing unit is configured to perform the offloaded operation based on data read based on the first physical address.

5. The memory system as claimed in claim 2, wherein the processing unit is configured to lookup a second virtual address received from the at least one processor in the page buffer.

6. The memory system as claimed in claim 5, wherein the processing unit is configured to acquire a second physical address corresponding to the second virtual address by looking up the second virtual address in the mapping table, in response to failing to lookup the second virtual address in the page buffer.

7. The memory system as claimed in claim 1, wherein the at least one processor is further configured to add mapping information corresponding to a third virtual address to the mapping table, in response to mapping information of the third virtual address to be transmitted to the memory device not being comprised in the mapping table.

8. The memory system as claimed in claim 1, wherein the at least one processor and the memory device are configured to communicate based on a Compute Express Link (CXL) protocol.

9. A method of operating a host device and a memory device, the method comprising:
generating, by the host device, a virtual address for accessing the memory device;
configuring, by the host device, a mapping table comprising mapping information between the virtual address and a physical address of a first internal memory of the memory device;
transmitting, by the host device, the mapping table to the memory device; and
converting, by the memory device, the virtual address to the physical address of the first internal memory based on the mapping table.

10. The method as claimed in claim 9, wherein the configuring the mapping table comprises updating the mapping table based on a first virtual address corresponding to an offloading, prior to offloading an operation to the memory device.

11. The method as claimed in claim 10, wherein the converting the virtual address to the physical address of the first internal memory comprises converting the first virtual address to a first physical address based on the updated mapping table, and
wherein the method further comprises performing the offloaded operation based on data read based on the first physical address.

12. The method as claimed in claim 9, wherein the configuring the mapping table comprises adding mapping information corresponding to a second virtual address to the mapping table, in response to mapping information of the second virtual address to be transmitted to the memory device not being comprised in the mapping table.

13. The method as claimed in claim 9, wherein the host device and the memory device are configured to communicate based on a Compute Express Link (CXL) protocol.

14. A memory system comprising a host device and a memory device, wherein the host device comprises:
a host memory configured to store instructions; and
at least one processor communicating with the host memory and configured to access the memory device by executing the instructions,
wherein the memory device comprises:
an internal memory comprising a first internal memory and a second internal memory; and
a processing unit configured to convert an address to perform an operation,
wherein the at least one processor is configured to:
generate a virtual address for offloading an operation to the memory device;
configure a mapping table comprising mapping information between the virtual address and a physical address of the first internal memory of the memory device; and
transmit the mapping table to the memory device, and
wherein the processing unit is configured to convert the virtual address to the physical address based on the mapping table, and perform the operation offloaded by the host device based on data read from the first internal memory based on the physical address.

15. The memory system as claimed in claim 14, wherein the host device is further configured to add mapping information corresponding to a first virtual address to the mapping table, in response to mapping information of the first virtual address generated for offloading a first operation not being comprised in the mapping table.
